(19) United States
(12) Patent Application Publication
(10) Pub. No.: US 2015/0266010 A1
(43) Pub. Date: Sep. 24, 2015

(54) MOF FORMED BY EXTRUSION AND PELLETIZING WITH A HYDRAULIC BINDER HAVING IMPROVED MECHANICAL PROPERTIES AND PROCESS FOR PREPARING SAME

(71) Applicant: IFP ENERGIES NOUVELLES, Rueil-Malmaison (FR)

(72) Inventors: Delphine Bazer-Bachi, Irigny (FR); Bogdan Harbuzaru, Valencia-Espagne (FR); Eric Lecolier, Chaville (FR)

(73) Assignee: IFP Energies nouvelles, Rueil-Malmaison (FR)

(21) Appl. No.: 14/427,786

(22) PCT Filed: Sep. 6, 2013
(86) PCT No.: PCT/FR2013/052052

§ 371 Date: Mar. 12, 2015

(30) Foreign Application Priority Data
Sep. 12, 2012 (FR) 12/02431

(51) Int. Cl. B01J 31/22; B01J 37/08; B01J 37/04

(52) U.S. Cl. CPC B01J 31/2295; B01J 37/04; B01J 37/08; B01J 2531/26

(57) ABSTRACT

The invention relates to a novel material comprising at least one crystalline organic-inorganic hybrid material (MHOIC) formed with a binding formulation comprising at least one hydraulic binder. The invention also relates to a process for preparing said material, comprising at least one step of mixing at least one powder of at least one crystalline organic-inorganic hybrid material with at least one powder of at least one hydraulic binder and at least one solvent, and a step of forming, preferably by pelletizing or extruding, the mixture obtained at the end of the mixing step.

The present invention relates to the field of crystalline organic-inorganic hybrid materials (COIHM), in particular the forming thereof with a view to using them in industrial applications for catalysis, storage or separation. More precisely, this invention relates to a novel crystalline organic-inorganic hybrid material (COIHM) formed using a binding formulation comprising at least one hydraulic binder. The present invention also relates to the preparation method of said novel formed COIHM.

### PRIOR ART

Hereinafter, by crystalline organic-inorganic hybrid material (COIHM) is meant any crystalline material containing organic and inorganic entities (atoms, clusters) connected by chemical bonds. Among this class of materials there may be mentioned, non limitatively, the MOFs (Metal Organic Framework), the coordination polymers, the ZIFs (Zeolitic Imidazolate Frameworks), the MILs (Matériaux de l'Institut Lavoisier [Materials of the Institut Lavoisier]), and the IRMOFs (IsoReticular Metal Organic Framework). These crystalline organic-inorganic hybrid materials (COIHM) were described with first examples in the 1960s, and form the subject of an increasing number of publications. The excitement around by these materials allowed an advanced structural diversity to be achieved in a short time (Férey G., l'Actualité Chimique, January 2007, No. 304). Conceptually, these porous hybrid materials with a mixed organic-inorganic matrix (COIHM) are fairly similar to porous materials with an inorganic framework Like the latter, they combine chemical entities, giving rise to porosity. The main difference lies in the nature of these entities. This difference is particularly advantageous and accounts for the great versatility of this category of hybrid materials. In fact, by using organic ligands, the pore size is adjustable via the length of the carbon chain of said organic ligands. The framework, which in the case of inorganic porous materials can only accept certain elements (Si, Al, Ge, Ga, P and possibly Zn), can in this case accommodate all cations.

It is therefore clear that this family of crystalline organic-inorganic hybrid materials (COIHM) allows a multiplicity of structures and consequently comprises solids that are finely adapted to the applications for which they are intended.

The crystalline organic-inorganic hybrid materials (COIHM) comprise at least two elements called connectors and ligands, of which the orientation and the number of binding sites are decisive in the structure of said hybrid material. As already mentioned, the diversity of these ligands and connectors leads to an immense variety of hybrid materials.

By “ligand” is meant the organic moiety of said hybrid material. Most often these ligands are di- or tricarboxylates or nitrogen-containing, sulphur-containing or pyridine derivatives. Some frequently encountered organic ligands are as follows: bdc=benzene-1,4-dicarboxylate, btc=benzene-1,3,5-tricarboxylate, ndc=naphthalene-2,6-dicarboxylate, bpy=4,4′-bipyridine, hfipbb=4,4′-(hexafluoroisopropylidene)-bisbenzoate, cyclam=1,4,8,11-tetraazacyclotetradecane, imz=imidazolates.

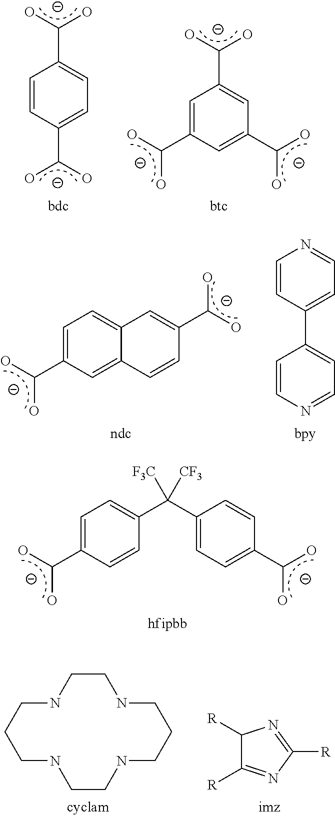

By “connector” is meant the inorganic entity of said hybrid material. It may be a cation on its own, a dimer, trimer or tetramer or a chain, a flat structure or a cluster.

Thus, teams of Yaghi and Férey have described a large number of new crystalline organic-inorganic hybrid materials (COIHM) (MOF series—“Metal Organic Framework”—and MIL series—“Matériaux de l'Institut Lavoisier”—respectively). Many other teams have followed this route and the number of new hybrid materials described is now increasing rapidly. Most often, it is the aim of research to develop ordered structures, having extremely large pore volumes, a good thermal stability and adjustable chemical functionalities.

For example, Yaghi et al. describe a series of structures based on boron in US patent application 2006/0154807 and point out their advantages in the field of gas storage. U.S. Pat. No. 7,202,385 discloses a particularly complete overview of the structures described in the literature and provides a perfect illustration of the multitude of hybrid materials now in existence.

Moreover, this variety of materials may be further extended by methods of functionalization recently described in the literature (Savonnet et al., Generic postfunctionalization route from amino-derived metal-organic frameworks, J. Am. Chem. Soc., 132 (2010) 4518-4519).

Hereinafter, for reasons of simplicity, the acronyms COIHM or MOF will be used as equivalents for describing all of the crystalline hybrid materials described above, including the materials obtained by post-modification of the latter (impregnation, deposition of active phases, functionalization, etc.).

The synthesis of crystalline organic-inorganic hybrid materials (COIHM) is particularly documented both in the patent literature and in the literature within the public domain. Now, these powders must be formed in order to envisage a use in industrial applications, and few references are available in this area, as indicated by Tagliabue et al.

The forming of crystalline organic-inorganic hybrid materials (COIHM) is generally undertaken by a compaction technique: either by direct compression (Tagliabue et al., Methane storage on CPO-27 pellets, J. Porous Mater (2011) 18, 289-296), or by adding polymer binders (Finsy et al., Separation of CO₂/CH₄ mixtures with the MIL53(A1) metal-organic framework, Microporous and mesoporous materials, 120 (2009) 221-227) or more rarely an alumina or carbon blacks (Cavenati et al., Metal organic framework adsorbent for biogas upgrading, Ind. Eng. Chem. Res. 2008, 47, 6333-6335).

However, this type of forming is unsuitable for applications in the presence of water or with liquid reagents/products. In these instances, the mechanical strength conferred by soluble polymer binders cannot withstand long periods of industrial use. Likewise, in the case of direct compression without binder, capillary forces and solvent penetration may lead to the destruction of the material and the generation of fines, with disastrous consequences for the process.

An objective of the present invention is to provide a novel material comprising at least one crystalline organic-inorganic hybrid material (COIHM) formed with at least one hydraulic binder, said material having enhanced mechanical properties, in particular in terms of mechanical strength, and also being resistant to a rise in temperature compatible with the crystalline organic-inorganic hybrid material (COIHM).

Another objective of the present invention is to provide a process for the preparation of said material according to the invention, said material obtained having good mechanical strength and being suitable for use in the presence of a solvent and therefore in an industrial process over long periods.

### SUMMARY OF THE INVENTION

The present invention relates to a material comprising at least one crystalline organic-inorganic hybrid material (COIHM) formed with a binding formulation comprising at least one hydraulic binder.

The present invention also relates to a process for the preparation of said material according to the invention comprising at least the following steps:
a) a step of mixing at least one powder of at least one crystalline organic-inorganic hybrid material (COIHM) with at least one powder of at least one hydraulic binder and at least one solvent in order to obtain a mixture,
b) a step of forming the mixture obtained at the end of step a).

An advantage of the present invention is that it proposes a preparation process allowing a material to be obtained comprising at least one crystalline organic-inorganic hybrid material (COIHM) formed with a binding formulation comprising at least one hydraulic binder, said material having enhanced mechanical properties, in particular in terms of mechanical strength, and being resistant to a rise in temperature, which makes it possible to envisage the application of said material in processes in the presence of water or solvents and at relatively high temperatures, but which are nevertheless limited by the temperature stability of the crystalline organic-inorganic hybrid material (COIHM).

Another advantage of the present invention is that it proposes a unique process for the preparation of said material according to the invention, which can be carried out regardless of the content of crystalline organic-inorganic hybrid material (COIHM), said process allowing materials to be obtained having good mechanical strength and therefore usable in fixed-bed applications.

### DETAILED DESCRIPTION

According to the invention, said material comprises at least one crystalline organic-inorganic hybrid material (COIHM) formed with a binding formulation comprising at least one hydraulic binder.

Said crystalline organic-inorganic hybrid material(s) (COIHM) used in the material according to the present invention are preferably selected from MOFs (Metal Organic Framework), ZIFs (or Zeolitic Imidazolate Frameworks), MILs (or Matériaux de l'Institut Lavoisier), and IRMOFs (or IsoReticular Metal Organic Frameworks), alone or in a mixture.

Preferably, said crystalline organic-inorganic hybrid material(s) (COIHM) used in the material according to the present invention are selected from following list: SIM-1, HKUST, CAU-1, MOF-5, MOF-38, MOF-305, MOF-37, MOF-12, IRMOF-2 to -16, MIL-53, MIL-68, MIL-101, ZIF-8, ZIF-11, ZIF-67, ZIF-90.

Said hydraulic binder(s) of the binding formulation with which said crystalline organic-inorganic hybrid material is formed is (are) advantageously selected from the hydraulic binders well known to a person skilled in the art. Preferably, said hydraulic binder(s) is (are) selected from Portland cement, high-alumina cements such as for example aluminous cement, Ternal, SECAR 51, SECAR 71, SECAR 80, the sulphoaluminous cements, plaster, cements with phosphate bonds such as for example phospho-magnesium cement, the blast furnace slag cements and the mineral phases selected from alite (Ca₃SiO₅), belite (Ca₂SiO₄), alumino-ferrite (or brownmillerite: of semi-formula Ca₂(Al,Fe³⁺)₂O₅), tricalcium aluminate (Ca₃Al₂O₆), and calcium aluminates such as monocalcium aluminate (CaAl₂O₄), calcium hexaaluminate (CaAl₁₂O₁₈), used alone or in a mixture.

Even more preferably the hydraulic binder is selected from Portland cement and the high-alumina cements.

Said hydraulic binder allows forming of said material according to the invention and endows it with good mechanical strength.

Said binding formulation comprising at least one hydraulic binder may also optionally comprise at least one source of silica.

In the case where said binding formulation also comprises at least one source of silica, said source of silica is advantageously selected from precipitated silica and silica originating from by-products such as fly-ash, for example silica-alumina or silica-calcium particles, and fumed silica.

Preferably, the source of silica has a size less than 10 μm, and preferably less than 5 μm, more preferably under 1 μm.

Preferably, the source of silica is in amorphous or crystalline form.

Said binding formulation comprising at least one hydraulic binder may also optionally comprise at least one organic adjuvant.

In the case where said binding formulation also comprises at least one organic adjuvant, said organic adjuvant is advantageously selected from cellulose derivatives, polyethylene glycols, aliphatic monocarboxylic acids, alkylated aromatic compounds, salts of sulphonic acid, fatty acids, polyvinyl pyrrolidone, polyvinyl alcohol, methylcellulose, polyacrylates, polymethacrylates, polyisobutene, polytetrahydrofuran, starch, polymers of the polysaccharide type (such as xanthan gum), scleroglucan, derivatives of the hydroxyethylated cellulose type, carboxymethylcellulose, lignosulphonates and derivatives of galactomannan, used alone or in a mixture.

Said organic adjuvant may also be selected from all the adjuvants known to a person skilled in the art.

Preferably, said material has the following composition:
1 to 99% by weight, preferably from 5 to 99% by weight, preferably from 7 to 99% by weight, and very preferably from 10 to 95% by weight of at least one crystalline organic-inorganic hybrid material (COIHM),
1 to 99% by weight, preferably from 1 to 90% by weight, preferably from 1 to 50% by weight, and very preferably from 1 to 20% by weight of at least one hydraulic binder,
0 to 20% by weight, preferably from 0 to 15% by weight, preferably from 0 to 10% by weight, and very preferably from 0 to 5% by weight of at least one source of silica,
0 to 20% by weight, preferably from 1 to 15% by weight, preferably from 1 to 10% by weight, and very preferably from 1 to 7% by weight of at least one organic adjuvant, the percentages by weight being expressed with respect to the total weight of said material and the sum of the contents of each of the compounds of said material being equal to 100%.

Said material according to the present invention is advantageously in the form of extrudates, beads or pellets.

Said materials according to the invention have enhanced mechanical properties, in particular in terms of mechanical strength, whatever the content of crystalline organic-inorganic hybrid material (COIHM) employed, and are resistant to a rise in temperature, which makes it possible to envisage the application of said material in processes in the presence of water or solvents and at relatively high temperatures, but which are nevertheless limited by the temperature stability of the crystalline organic-inorganic hybrid material (COIHM).

Said materials according to the invention may therefore be used for applications in catalysis and separation.

In particular, said materials according to the invention have a mechanical strength measured by the average crushing strength test, denoted ACS hereafter, at least greater than 0.4 daN/mm and preferably at least greater than 0.9 daN/mm and preferably at least greater than 1 daN/mm. These properties of mechanical strength are maintained, including after heat treatment up to 500° C. (when the associated crystalline organic-inorganic hybrid material withstands these temperatures) and for compositions of materials comprising up to 95% by weight of crystalline organic-inorganic hybrid material with respect to the total weight of said material.

By “mechanical strength to lateral crushing” is meant the mechanical strength of the material according to the invention determined by the average crushing strength test (ACS). It is a standardized test (ASTM standard D4179-01), which consists of subjecting a material in the form of an object of millimetric size, such as a bead, a pellet or an extrudate, to a compressive force, causing rupture. This test is therefore a measurement of the tensile strength of the material. The analysis is repeated on a certain number of solid objects taken individually and typically on a number of solid objects between 10 and 200. The mean value of the lateral rupture forces measured constitutes the mean ACS, which is expressed in the case of granules as a unit of force (N), and in the case of extrudates as a unit of force per unit of length (daN/mm or decanewton per millimetre of length of extrudate).

The present invention also relates to a process for the preparation of said material according to the invention comprising at least the following steps:
a) a step of mixing at least one powder of at least one crystalline organic-inorganic hybrid material (COIHM), with at least one powder of at least one hydraulic binder and at least one solvent in order to obtain a mixture,
b) a step of shaping the mixture obtained at the end of step a).

### Step a):

According to the invention, said step a) consists of mixing at least one powder of at least one crystalline organic-inorganic hybrid material (COIHM), with at least one powder of at least one hydraulic binder and at least one solvent in order to obtain a mixture.

Preferably, at least one source of silica and optionally at least one organic adjuvant are also mixed during step a).

Preferably, at least said source of silica and optionally at least said organic adjuvant may be mixed in the form of powder or in solution in said solvent.

Said solvent is advantageously selected from water, ethanol, alcohols and amines. Preferably, said solvent is water.

Within the context of the invention, it is entirely conceivable to carry out mixing several different powders of crystalline organic-inorganic hybrid materials (COIHM) and/or powders of different sources of silica and/or powders of different hydraulic binders.

The mixing of the powders of at least one crystalline organic-inorganic hybrid material (COIHM), of at least one hydraulic binder, optionally of at least one source of silica and optionally of at least one organic adjuvant in the case when the latter are mixed in the form of powders, with at least one solvent, is carried out in any order whatsoever.

The mixing of said powders and of said solvent may advantageously be carried out just once.

The additions of powders and of solvent may also advantageously be alternated.

Preferably, said powders of at least one crystalline organic-inorganic hybrid material

(COIHM), of at least one hydraulic binder, optionally of at least one source of silica and optionally of at least one organic adjuvant, in the case when the latter are mixed in the form of powders, are first premixed, dry, before the introduction of solvent.

Said premixed powders are then advantageously brought into contact with said solvent.

In another embodiment, at least said source of silica and at least said organic adjuvant may be in solution or in suspension in said solvent beforehand when said solvent is brought into contact with the powders of at least one crystalline organic-inorganic hybrid material (COIHM) and of at least one hydraulic binder. Bringing into contact with said solvent leads to the production of a mixture, which is then mixed.

Preferably, said mixing step a) is carried out by mixing, in a batch operation or a continuous operation.

In the case where said step a) is carried out as a batch operation, said step a) is advantageously carried out in a mixer preferably equipped with Z arms, or with cams, or in any other type of mixer, such as for example a planetary mixer. Said mixing step a) makes it possible to obtain a homogeneous mixture of the pulverulent constituents.

Preferably, said step a) is carried out for a duration comprised between 5 and 60 min, and preferably between 10 and 50 min. The speed of rotation of the mixer arms is advantageously comprised between 10 and 75 rpm, preferably between 25 and 50 rpm.

Preferably,
from 1 to 99% by weight, preferably from 5 to 99% by weight, preferably from 7 to 99% by weight, and very preferably from 10 to 95% by weight of at least one powder of at least one crystalline organic-inorganic hybrid material (COIHM),
from 1 to 99% by weight, preferably from 1 to 90% by weight, preferably from 1 to 50% by weight, and very preferably from 1 to 20% by weight of at least one powder of at least one hydraulic binder,
optionally from 0 to 20% by weight, preferably from 0 to 15% by weight, preferably from 0 to 10% by weight, and very preferably from 0 to 5% by weight of at least one source of silica, preferably in the form of powder,
optionally from 0 to 20% by weight, preferably from 1 to 15% by weight, preferably from 1 to 10% by weight, and very preferably from 1 to 7% by weight of at least one organic adjuvant, preferably in the form of powder,
   are introduced in step a), the percentages by weight being expressed with respect to the total quantity of compounds and preferably of powders introduced in said step a) and the sum of the quantities of each of the compounds and preferably of the powders introduced in said step a) being equal to 100%.

### Step b):

According to the invention, said step b) consists of shaping the mixture obtained at the end of the mixing step a).

Preferably, the mixture obtained at the end of the mixing step a) is advantageously shaped by extrusion or by pelletizing.

In the case where the shaping of the mixture from step a) is carried out by extrusion, said step b) is advantageously carried out in a single-screw or twin-screw ram extruder.

In this case, an organic adjuvant may optionally be added in the mixing step a). The presence of said organic adjuvant facilitates the forming by extrusion. Said organic adjuvant is described above and is introduced in step a) in the proportions indicated above.

In the case where said process of preparation is carried out continuously, said mixing step a) may be coupled with step b) for the shaping by extrusion in one and the same piece of equipment. According to this implementation, the extrusion of the mixture, also called “kneaded paste”, may be carried out either by extruding directly at the end of a continuous mixer of the twin-screw type for example, or by connecting one or more batch mixers to an extruder. The geometry of the die, which gives the extrudates their shape, may be selected from the dies well known to a person skilled in the art. They may thus be, for example, cylindrical, multilobed, grooved shape, or with slits.

In the case where the shaping of the mixture from step a) is carried out by extrusion, the quantity of solvent added in the mixing step a) is adjusted so as to obtain, at the end of this step and regardless of the variant implemented, a mixture or a paste that does not flow but is not too dry either, so as to allow its extrusion under suitable conditions of pressure which are well known to a person skilled in the art and are dependent on the extrusion equipment used.

Preferably, said step b) of shaping by extrusion is carried out at an extrusion pressure greater than 1 MPa and preferably between 3 MPa and 10 MPa.

In the case where the shaping of the mixture from step a) is carried out by pelletizing, the quantity of solvent employed in the mixing step a) is adjusted in order to allow easy filling of the pelletizing dies and pelletizing under suitable conditions of pressure which are well known to a person skilled in the art and are dependent on the pelletizing equipment used. Preferably, said step b) of shaping by pelletizing is carried out at a compressive force greater than 1 kN and preferably between 2 kN and 20 kN. The geometry of the pelletizing die, which gives the pellets their shape, may be selected from the dies well known to a person skilled in the art. They may thus be, for example, of cylindrical shape. The dimensions of the pellets (diameter and length) are adapted so as to be suitable for the requirements of the process in which they will be used. Preferably, the pellets have a diameter between 0.3 and 10 mm and a ratio of diameter to height preferably between 0.25 and 10.

The process for the preparation of said material according to the invention may also optionally comprise a step c) of maturation of the shaped material obtained at the end of step b). Said maturation step is advantageously carried out at a temperature comprised between 0 and 300° C., preferably between 20 and 200° C. and preferably between 20 and 150° C., for a duration comprised between 1 minute and 72 hours, preferably between 30 minutes and 72 h, and preferably between 1 h and 48 h and more preferably between 1 and 24h.

Preferably, said maturation step is carried out under air and preferably under humid air with a relative humidity between 20 and 100% and preferably between 70 and 100%. This step allows good hydration of the material which is necessary for a complete setting of the hydraulic binder.

The shaped material originating from the forming step b) or the maturation step c) may also optionally undergo a calcination step d) at a temperature comprised between 50 and 500° C., preferably between 100 and 300° C. for a duration comprised between 1 and 6 h and preferably between 1 and 4 h. This calcination step is in particular useful for removing the organic adjuvants used for facilitating the shaping of the material.

Said optional calcination step d) is advantageously carried out under a gas stream comprising oxygen, for example preferably the extrudates are calcined under dry air or air with different levels of humidity or they are heat-treated in the presence of a gas mixture comprising an inert gas, preferably nitrogen, and oxygen. The gas mixture used preferably comprises at least 5% by volume, or even preferably at least 10% by volume of oxygen.

The temperature of said calcination step d) is advantageously comprised between 50° C. and the degradation temperature of the crystalline organic-inorganic hybrid material (COIHM) or of the most fragile of the crystalline organic-inorganic hybrid materials (COIHMs) used in the material according to the present invention, preferably between 150 and 350° C. for a duration comprised between 1 and 6 h and preferably between 2 and 4 h.

At the end of the process for the preparation of the material according to the invention, the material obtained is in the form of extrudates or pellets.

However, it is not excluded that said materials obtained are then, for example, introduced into equipment for rounding their surface, such as a tumbler or any other equipment for spheronization.

Said preparation process according to the invention makes it possible to obtain materials according to the invention having values of mechanical strength measured by average crushing strength greater than 0.4 daN/mm, preferably greater than 0.9 daN/mm and preferably greater than 1 daN/mm, whatever the content of COIHM employed.

The material obtained at the end of the preparation process according to the invention may be used for applications in catalysis, separation, purification, capture, etc.

Said material is brought into contact with the gaseous feedstock to be treated in a reactor, which may be either a fixed-bed reactor, or a radial reactor, or a fluidized-bed reactor.

In the case of an application in the areas of catalysis and separation, the expected value of ACS is greater than 0.9 daN·mm⁻¹, preferably greater than 1.0 daN·mm⁻¹.

The examples given below illustrate the invention without limiting its scope.

### EXAMPLES

In order to illustrate the invention, several preparation methods are described, based on the forming of a crystalline organic-inorganic hybrid material (COIHM): ZIF-8, available commercially under the brand name Basolite Z1200 (Sigma Aldrich).

### Example 1 (Comparative)

ZIF-8 powder is pelletized using a compression machine made by MTS with instrumentation for pressure and displacement and equipped with a system consisting of a die and punches and allowing the manufacture of compacts. The diameter of the device selected for these tests is 4 mm. The die is fed with ZIF-8 powder and a force of 7 kN is applied to the system.

The compacts obtained have the following characteristics: S_{BET}=1340 m²/g, ACS=0.7 daN/mm.

Analysis of these compacts by X-ray diffraction shows a loss of crystallinity due to this method of forming, which is also reflected in a decrease in specific surface area (which was 1430 m²/g for the powder of Basolite Z1200). The pellets easily disintegrate on contact with a solvent (tests carried out with water and with ethanol).

### Example 2 (COIHM Formed by Extrusion According to the Invention)

Preparation of the solid, 65% of COIHM: powders of MOF ZIF-8 (67% by weight), of silica (5.8%), of portland cement (Black label produced by Dyckerhoff) (22.4%) and of Methocel (K15M) (4.8%) are introduced into a mixer made by Brabender and premixed. Water is added dropwise until a paste is obtained and mixing is continued for 20 minutes. The paste obtained is then extruded on a ram extruder made by MTS using a cylindrical die with a diameter of 3 mm.

The extrudates are stored under ambient conditions for the setting time of the cement (48 hours).

The extrudates obtained have an ACS value of 2.5 daN/mm and an S_{BET} of 900 m²/g

### Example 3 (COIHM Formed by Extrusion According to the Invention: Effect of Post-Treatment)

Preparation of the solid, 65% COIHM: preparation is similar to that in Example 2 except that the material formed by extrusion then undergoes a maturation step at a temperature of 20° C. for 48 h, under humid air comprising 100% by weight of water.

In this case, the mechanical strength is further improved with a ACS of 3.2 daN/mm.

### Example 4 (COIHM Formed by Extrusion According to the Invention)

Preparation of the solid, 80.9% ZIF-8: the preparation method is identical to Example 2 except that the proportions by weight of the various components are: 11.4% of portland cement (Black label produced by Dyckerhoff), 2.9% of silica and 4.8% of Methocel and that the material formed by extrusion then undergoes a maturation step at a temperature of 20° C. for 48 h, under humid air comprising 100% by weight of water.

The extrudates obtained have an ACS value of 2 daN/mm and an S_{BET} of 1100 m²/g.

### Example 5 (COIHM Formed by Pelletizing According to the Invention)

Powders of ZIF-8 (90% by weight), of portland cement (Black label produced by Dyckerhoff) (5%) and of Methocel (K15M) (5%) are introduced into a mixer made by Brabender and premixed with 10% of water based on the total weight of the powders for 15 minutes. The mixture obtained is pelletized using a compression machine made by MTS with instrumentation for pressure and displacement and equipped with a system consisting of a die and punches and allowing the manufacture of compacts. The diameter of the device selected for these tests is 4 mm. A force of 5 kN is applied to the system. The material formed by pelletizing then undergoes a maturation step at a temperature of 20° C. for 4 days, under humid air comprising 100% by weight of water. The compacts obtained have the following characteristics: S_{BET}=1150 m²/g, ACS=1 daN/mm.

The pellets do not disintegrate on contact with a solvent (tests carried out with water and with ethanol).

### Example 6 (COIHM Formed by Extrusion According to the Invention)

Preparation of the solid, 95% ZIF-8: the preparation method is identical to Example 2 except that the proportions by weight of the various components are: 4% of portland cement (Black label produced by Dyckerhoff) and 1% of Methocel, and that the formed material then undergoes a maturation step at a temperature of 20° C. for 48 h, under humid air comprising 100% by weight of water for 48 h.

The extrudates obtained have an ACS value of 1.1 daN/mm and an S_{BET} of 1350 m²/g.

1. Material comprising at least one crystalline organic-inorganic hybrid material formed with a binding formulation comprising at least one hydraulic binder.

2. Material according to claim 1, in which said crystalline organic-inorganic hybrid material is preferably selected from MOF, ZIFs, MILs and IRMOFs, alone or in a mixture.

3. Material according to claim 1, in which said hydraulic binder is selected from Portland cement, the high-alumina cements, the sulphoaluminous cements, plaster, cement with phosphate bonds, blast furnace slag cements and the mineral phases selected from alite (Ca₃SiO₅), belite (Ca₂SiO₄), alumino-ferrite (or brownmillerite: of semi-formula Ca₂(Al,Fe³⁺)₂O₅)), tricalcium aluminate (Ca₃Al₂O₆), calcium aluminates such as monocalcium aluminate (CaAl₂O₄), calcium hexaaluminate (CaAl₁₂O₁₈), used alone or in a mixture.

4. Material according to claim 3, in which the hydraulic binder is selected from Portland cement and the high-alumina cements.

5. Material according to claim 1, in which said binding formulation also comprises at least one source of silica.

6. Material according to claim 1, in which said binding formulation also comprises at least one organic adjuvant selected from cellulose derivatives, polyethylene glycols, aliphatic monocarboxylic acids, alkylated aromatic compounds, salts of sulphonic acid, fatty acids, polyvinyl pyrrolidone, polyvinyl alcohol, methylcellulose, polyacrylates, polymethacrylates, polyisobutene, polytetrahydrofuran, starch, polymers of the polysaccharide type, scleroglucan, derivatives of the hydroxyethylated cellulose type, carboxymethylcellulose, lignosulphonates and derivatives of galactomannan, used alone or in a mixture.

7. Material according to claim 1, in which said material has the following composition:
1 to 99% by weight of at least one crystalline organic-inorganic hybrid material (COIHM),
1 to 99% by weight of at least one hydraulic binder,
0 to 20% by weight of at least one source of silica,
0 to 20% by weight of at least one organic adjuvant, the percentages by weight being expressed with respect to the total weight of said material and the sum of the contents of each of the compounds of said material being equal to 100%.

8. Material according to claim 7, in which said material has the following composition:
10 to 95% by weight of at least one crystalline organic-inorganic hybrid material (COIHM),
1 to 20% by weight of at least one hydraulic binder,
0 to 5% by weight of at least one source of silica,
1 to 7% by weight of at least one organic adjuvant, the percentages by weight being expressed with respect to the total weight of said material and the sum of the contents of each of the compounds of said material being equal to 100%.

9. Material according to claim 1, in which said material is in the form of extrudates, beads or pellets.

10. Process for the preparation of the material according to claim 1 comprising at least the following steps:
a) a step of mixing at least one powder of at least one crystalline organic-inorganic hybrid material (COIHM) with at least one powder of at least one hydraulic binder and at least one solvent in order to obtain a mixture,
b) a step of shaping the mixture obtained at the end of step a).

11. Preparation process according to claim 10, in which at least one source of silica is also mixed during step a).

12. Preparation process according to claim 10, in which at least one organic adjuvant is also mixed during step a).

13. Preparation process according to claim 10, in which said step b) is carried out by extrusion or by pelletizing.

14. Preparation process according to claim 10, in which said preparation process also comprises a step c) of maturation of the shaped material obtained at the end of step b), said maturation step being carried out at a temperature comprised between 0 and 300° C., for a duration comprised between 1 hour and 48 hours.

15. Preparation process according to claim 14, in which said maturation step is carried out under air and preferably under humid air containing between 20 and 100% by weight of water.

16. Preparation process according to claim 14, in which said preparation process also comprises a calcination step d) at a temperature comprised between 50 and 500° C., for a duration comprised between 1 and 6 h.
